(19) United States
(12) Patent Application Publication
(10) Pub. No.: US 2009/0095350 A1
(43) Pub. Date: Apr. 16, 2009

(54) ACTUATOR FOR AN AIR INTAKE VALVE

(76) Inventors: Walter Douglas Bauman, Wixom, MI (US); Mark M. Rose, Myrtle Bearch, SC (US); Robert Joseph Burnstingle, JR., Marion, SC (US); Daniel J. Virga, Myrtle Beach, SC (US)

Correspondence Address: CARLSON, GASKEY & OLDS, P.C., 400 WEST MAPLE ROAD, SUITE 350, BIRMINGHAM, MI, 48009, US

(21) Appl. No.: 11/872,752

(22) Filed: Oct. 16, 2007

(51) Int. Cl. F16K 31/44; F16K 31/52

(52) U.S. Cl. 137/1; 251/231; 251/215

(57) ABSTRACT

An example valve for controlling airflow to an engine includes an actuator with an actuator arm that moves between extended and retracted positions, and a valve housing defining an airflow passage extending between a first housing opening and a second housing opening. The airflow passage has an axis X. The example valve also includes at least one finger within the valve housing. Movement of the actuator arm causes radial movement of the finger relative to the axis X, and the finger moves between a position that provides a restricted flow of air through the airflow passage, and a position that provides a greater flow of air through the airflow passage.

### TECHNICAL FIELD

The invention relates to an actuator controlled, adjustable air intake valve for a variable compression engine.

### DESCRIPTION OF THE RELATED ART

Vehicle engines are well known and require an air supply. Igniting or firing a compressed mixture of air and fuel within engine cylinder compression chambers powers the vehicle. Some engines use spark plugs to fire the mixture, while other engines rely on the heat of compression.

Variable compression engines include multiple cylinders, and typically include an air intake for supplying air to the cylinders. Variable compression engines change the number of firing cylinders to alter the engine's power output. The vehicle may require less power at cruising speeds, and therefore fire fewer cylinders. Additional cylinders fire as the vehicle's power requirements increase.

Variable compression engines typically require more air when the number of firing cylinders increases. Accordingly, the air moving to the engine increases as the number of firing cylinders increases. Changing the air supply to the engine may affect the engine's sound. That is, the sound from the engine fluctuates with changes in the speed of air moving through the air intake. With a consistently sized air intake, the airspeed through the intake slows as the air requirements decrease, and as the air requirements increase the airspeed increases. Formerly, variable compression engines produced unpleasant sound characteristics at some combinations of air requirements and air intake size.

Some engines attempt to alleviate the unpleasant sound characteristics by including more than one air intake, which provides additional paths for air to reach the engine when air requirements increase. Including additional intakes adds cost and complexity to the engine. Other engines include a butterfly valve for metering airflow through the air intake. Butterfly valves are positioned within the flow of air, which may increase turbulence in the air supplied to the engine. Turbulence can undesirably decrease the engine's efficiency.

It would be desirable to vary the air supply to a variable compression engine without requiring additional air intakes or increasing turbulence in the air supply.

### SUMMARY OF THE INVENTION

An example valve for controlling airflow to an engine includes an actuator with an actuator arm that moves between extended and retracted positions, and a valve housing defining an airflow passage extending between a first housing opening and a second housing opening. The airflow passage has an axis X. The example valve also includes at least one finger within the valve housing. Movement of the actuator arm causes radial movement of the finger relative to the axis X, and the finger moves between a position that provides a restricted flow of air through the airflow passage, and a position that provides a greater flow of air through the airflow passage.

An example actuator device for controlling a variable engine intake valve includes an actuator arm and an actuator for moving the actuator arm between a first position and a second position. A controller controls the position of the actuator arm. Moving the actuator arm to a first position causes a restricted airflow through an engine air intake valve and movement of the actuator to the second position causes a less restricted airflow through the engine air intake valve.

An example method of controlling airflow to an engine includes moving an actuator arm in a first direction to restrict airflow to an engine and moving the actuator arm in a second direction different from the first direction to permit greater airflow to the engine. The first and second directions are generally transverse to the airflow.

The various features and advantages of this invention will become apparent to those skilled in the art from the following detailed description. The accompanying drawings can be briefly described as follows.

### BRIEF DESCRIPTION OF THE DRAWINGS

FIG. 1 illustrates a perspective view of an example variable intake valve.

FIG. 2 illustrates a partial cutaway view of the example valve of FIG. 1.

FIG. 3 details an outer finger.

FIG. 4 details a link.

FIG. 5 illustrates a rear view of the inner fingers and the outer fingers mounted to the mounting plate.

FIG. 6 illustrates a front view of the example valve of FIG. 2.

FIG. 7 illustrates a front view of one of the inner fingers and one of the outer fingers mounted to the mounting plate.

### DETAILED DESCRIPTION OF THE PREFERRED EMBODIMENT

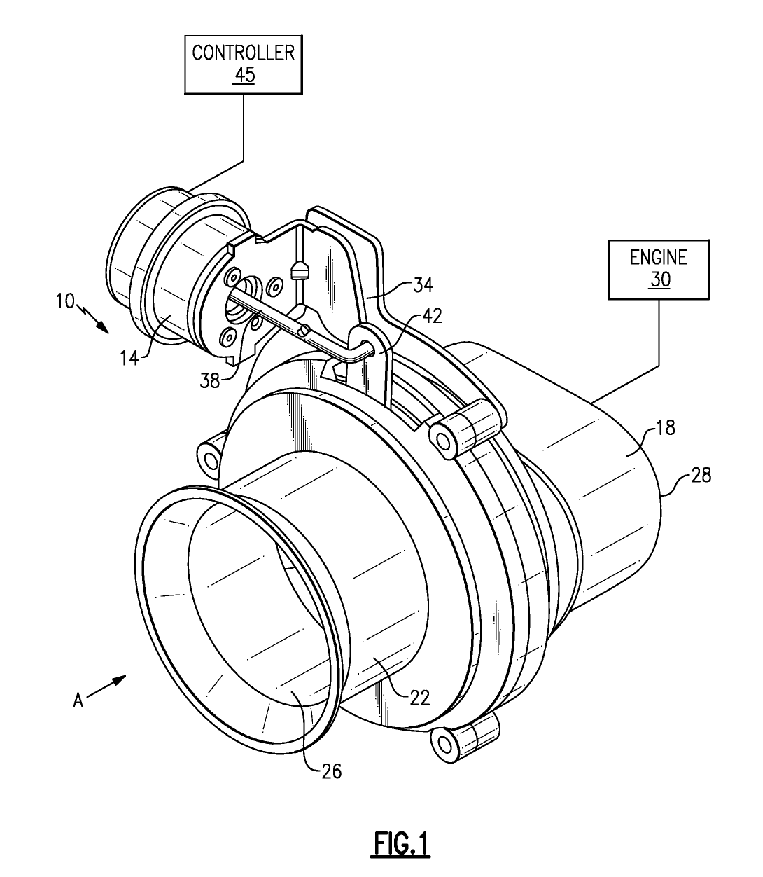

An example variable intake valve 10 includes an actuator 14 mounted adjacent an inner housing 18 and an outer housing 22, as shown in FIG. 1. The inner housing 18 and outer housing 22 define an airflow passage for communicating airflow A to a vehicular engine 30. Airflow A enters the variable intake valve through an outer housing opening 26 and exits through an opening 28 in the inner housing 18. The actuator 14 mounts to a bracket 34 attached to the inner housing 18 and the outer housing 22. The actuator 14 includes an actuator arm 38 pivotally connected to a link 42. A controller 45 controls the actuator 14 to position the actuator arm 38.

The actuator arm 38 moves between an extended position (shown) and a retracted position. In the extended position, the actuator arm 38 extends further from the actuator 14 than the retracted position. The actuator arm 38 may be infinitely adjustable between the extended and retracted positions (e.g., electric actuator). Alternatively, the actuator arm 38 moves between two defined positions (e.g., vacuum actuator). Adjusting the position of the actuator arm 38 rotates the link 42 to change the cross-sectional flow area through the intake valve 10.

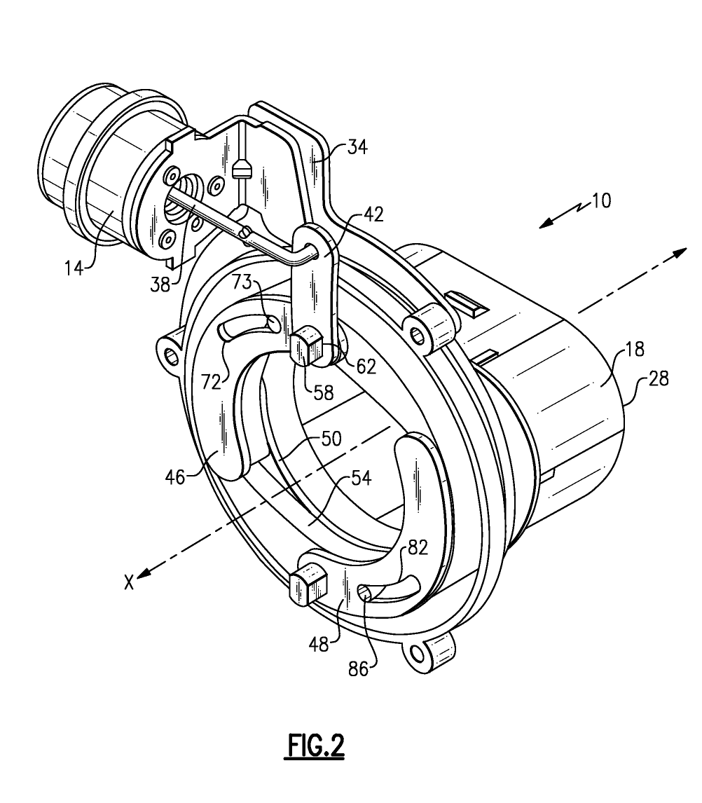

As shown in the cutaway view of FIG. 2, the variable intake valve 10 includes a central axis X through the airflow passage. The link 42 includes an aperture 62 for engaging an extension 58 of an outer finger 46 disposed about the axis X. The outer finger 46 pivotally attaches to a mounting plate 54 surrounding the axis X and moves between positions radially toward and radially away from the axis X. Retracting the actuator arm 38 rotates the link 42, which causes the actuator arm 38 or outer finger 46 to pivot toward the axis X. In this example, the outer finger 46 is shown in a radially outward position, which corresponds to an extended position of the actuator arm 38.

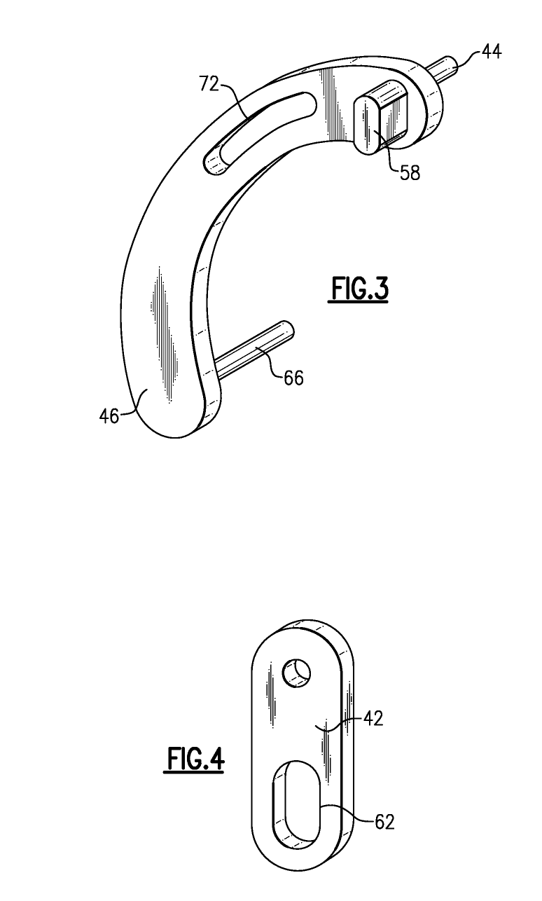

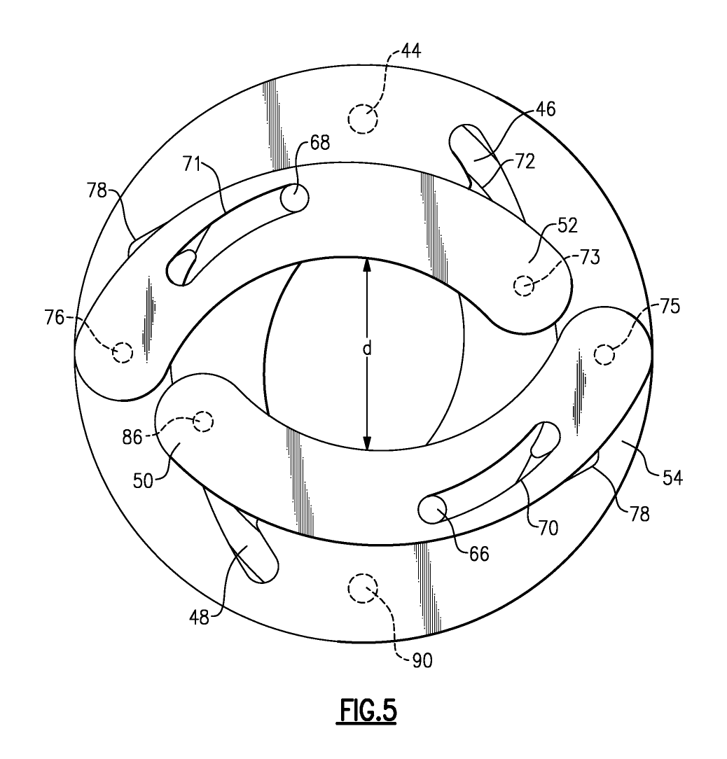

FIG. 3 illustrates detailed view of the outer finger 46. The link 42 with the aperture 62 is shown in FIG. 4. The extension 58 facilitates pivoting the outer finger 46 using the link 42. The outer finger 46 includes a mounting pin 44 for pivotally attaching the outer finger 46 to the mounting plate 54. Together, the extension 58 and the mounting pin 44 define an axis of rotation about which movement of the link 42 rotates the outer finger 46. The outer finger 46 also includes a driver pin 66 that pivots with the outer finger 46.

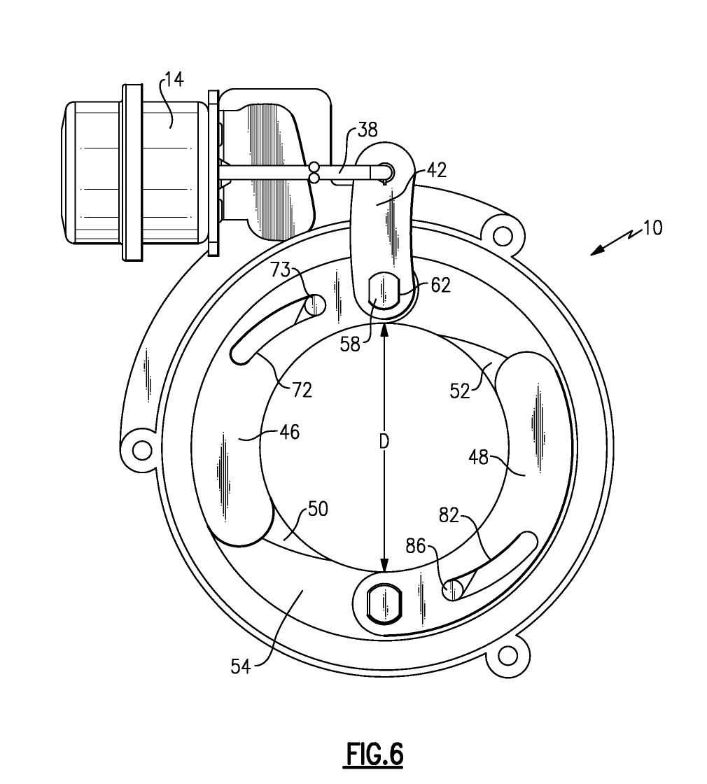

Referring now to the rear view of FIG. 5 with continuing reference to FIGS. 2 and 3, as the outer finger 46 pivots, the driver pin 66 moves an inner finger 50. The inner finger 50 pivotally attaches to an opposing side of the mounting plate 54 at pivot attachment 75. The driver pin 66 is longer than the mounting pin 44 and extends beyond the mounting plate 54 to move the inner finger 50. The inner finger 50 includes a slot 70 for receiving the driver pin 66. When the outer finger 46 pivots, the driver pin 66 presses against the sides of the slot 70 and forces the inner finger 50 to pivot about pivot attachment 75. Thus, as the link 42 moves the outer finger 46, the outer finger 46 moves the inner finger 50 with the driver pin 66.

The outer finger 46 also includes a slot 72 for receiving a driver pin 73 extending from a second inner finger 52. When the outer finger 46 pivots, the slot 72 presses against the driver pin 73 and forces the second inner finger 52 to pivot about pivot attachment 76. Thus, pivoting the outer finger 46 pivots both the inner fingers 50, 52.

The inner fingers 50, 52 mount adjacent a surface of the mounting plate 54 opposite the outer finger 46. In this example, the mounting locations of the inner fingers 50, 52 and the outer finger 46 arranged about the axis X. Another outer finger 48 mounts to the mounting plate 54 on the same side as outer finger 46. The mounting location of the inner fingers 50, 52 and the outer fingers 46, 48 are each offset to evenly distribute the fingers around the axis X.

The inner finger 50 includes driver pin 86 that extends past the mounting plate 54 into a slot 82 on the outer finger 48. The outer finger 48 moves with the driver pin 86 and the inner finger 50. The outer finger 48 also includes a driver pin 68 extending past the mounting plate 54 and received within a slot 71 on the second inner finger 52. As the second inner finger 52 pivots, the sides of the slot 71 press against the driver pin 68 to pivot the outer finger 48. Thus, the inner fingers 50, 52 combine to move the outer finger 48.

The inner fingers 50, 52 and the outer fingers 46, 48 have a similar shape and contain respective pivot points, driver pins, and slots. In one example, the fingers are formed of a molded polymer material cast from similar molds. The extension 58 may be molded-in and then removed from the fingers that do not need the feature. Alternatively, the extension 58 may be added after molding.

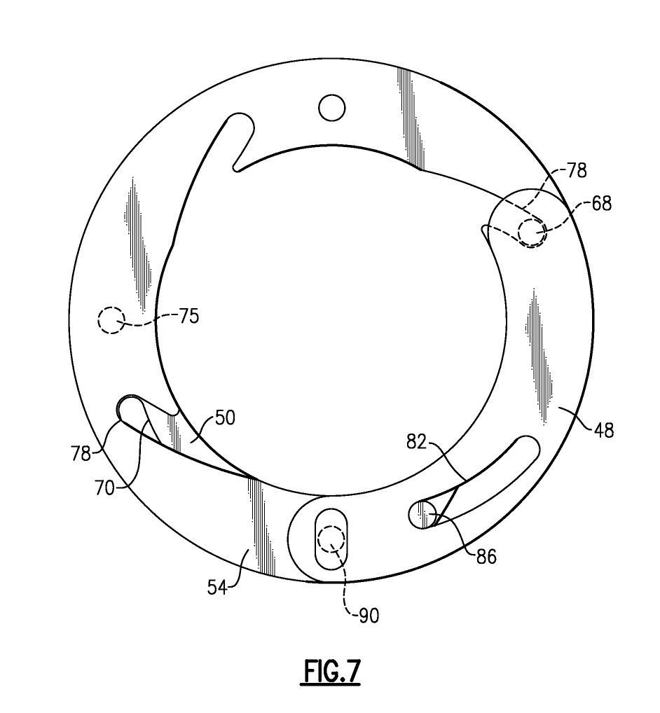

Pivoting the inner fingers 50, 52 and the outer fingers 46, 48 moves the fingers relative to the axis X to change the cross-sectional flow area through the valve 10. When less airflow to the engine 30 is desired, the actuator 14 retracts the actuator arm 38 to pivot the link 42 and move the inner fingers 50, 52, and outer fingers 46, 48 radially inward such that the flow cross-section of valve 10 is d, as shown in FIG. 5. A diameter d through the valve 10 decreases airflow by decreasing the cross-sectional flow area through the valve 10 from the diameter D of FIG. 6. In this example, the inner fingers 50, 52, and the outer fingers 46, 48 are shown in radially outward positions when the diameter is D.

FIG. 7 shows the relationship between the mounting plate 54 and the fingers 46, 48, 50, 52. In this example, the mounting plate 54 includes features for controlling movement of the outer fingers 46, 48 and the inner fingers 50, 52. For example, slots 78 within the mounting plate receive the corresponding driver pin 66, 68 during at least a portion of the range of pivoting movements of the outer fingers 46, 48. The slots 78 of the mounting plate 54 receive the middle portions of the pins 66, 68 as outer finger 46 moves to a radially outward position.

The example valve includes fingers 46, 48, 50, 52 that include engagement features such that radial movement relative to axis X of one finger causes a similar radial movement of the remaining fingers. The outer fingers 46, 48 and inner fingers 50, 52 attach to opposing sides of the mounting plate 54, which includes features for further controlling movements of the outer fingers 46, 48 and inner fingers 50, 52. The features of the outer fingers 46, 48, inner fingers 50, 52, and mounting plate 54 are in one example pins 66, 68, 86 and slots 70, 72, 82, 78 Other example features may include extensions received within depressions or other suitable designs.

Although an example invention has been disclosed, a worker of ordinary skill in the art may recognize that certain modifications are possible that come within the scope of this invention. For that reason, the following claims should be studied to determine the true scope of legal protection available.

What is claimed is:

1. A valve for controlling airflow to an engine, comprising:
an actuator including an actuator arm moveable between extended and retracted positions;
a valve housing defining an airflow passage positioned between a first housing opening and a second housing opening, said airflow passage having an axis; and
at least one finger within said valve housing, wherein movement of said actuator arm causes radial movement of said at least one finger relative to said axis, said at least one finger moveable between a position that provides a restricted flow of air through said airflow passage, and a position that provides a greater flow of air through said airflow passage.

2. The valve of claim 1, wherein said at least one finger pivotally attaches adjacent a surface of a mounting plate.

3. The valve of claim 2, wherein said surface is generally transverse to airflow through said airflow passage.

4. The valve of claim 2, wherein radial movement of said at least one finger aligns with a plane defined by said surface.

5. The valve of claim 1, wherein radial movement of said at least one finger causes radial movement of at least one other finger relative to said axis.

6. The valve of claim 2, including at least one other finger pivotally attached to another surface of said mounting plate such that said fingers sandwich a portion of said mounting plate.

7. The valve of claim 6, wherein pivoting movement of said at least one finger causes pivoting movement of said at least one other finger.

8. The valve of claim 7, wherein said at least one finger includes a slot for receiving a pin extending from said at least one other finger.

9. The valve of claim 1, including a link pivotally connected at a first end to said actuator arm and connected at a second end to said at least one finger, wherein movement of said actuator arm moves said link to move said at least one finger.

10. The valve of claim 1, wherein said axis is a central axis through said airflow passage.

11. A method of controlling airflow to an engine, comprising:
moving an actuator arm in a first direction to restrict an airflow to an engine; and
moving the actuator arm in a second direction different from the first direction to permit a greater airflow to the engine, wherein the first and second directions are generally transverse to the airflow.

12. The method of claim 11, including using the actuator arm to move a finger within a valve housing between a first position that restricts airflow and a second position that permits a greater airflow.

13. The method of claim 12, wherein the first position is radially inward of the second flow position relative to an axis defined by an airflow passage through said valve housing.

14. The method of claim 11, including moving the actuator arm to change the turbulence of the airflow to the engine.

15. The method of claim 11, including moving the actuator arm to change the sound of the engine.
